(19) United States
(12) Patent Application Publication
(10) Pub. No.: US 2012/0134448 A1
(43) Pub. Date: May 31, 2012

(54) DETECTION APPARATUS, DETECTION METHOD, AND RECEPTION APPARATUS

(75) Inventors: Shinichi Fukuda, Kanagawa (JP); Hiroaki Nakano, Tokyo (JP)

(73) Assignee: SONY CORPORATION, Tokyo (JP)

(21) Appl. No.: 13/297,387

(22) Filed: Nov. 16, 2011

(30) Foreign Application Priority Data
Nov. 26, 2010 (JP) P2010-263806

(51) Int. Cl. H04L 27/06

(52) U.S. Cl. 375/340

(57) ABSTRACT

A detection apparatus detects, from a carrier signal which has been subjected to load modulation in accordance with information to be transmitted, the information. The detection apparatus includes a buffer configured to buffer the received carrier signal which has been subjected to the load modulation, and a detector configured to perform detection on the buffered carrier signal which has been subjected to the load modulation so as to detect the information.

### CROSS-REFERENCE TO RELATED APPLICATION

The present application claims priority from Japanese Patent Application No. JP 2010-263806 filed in the Japanese Patent Office on Nov. 26, 2010, the entire content of which is incorporated herein by reference.

### BACKGROUND

The present disclosure relates to detection apparatuses, detection methods, and reception apparatuses, and particularly relates to a detection apparatus, a detection method, and a reception apparatus which are suitably used when, from a carrier signal which has been subjected to load modulation in accordance with information to be transmitted, the information is detected.

In recent years, noncontact communication systems typified by FeliCa (registered trademark of Sony Corporation) have been broadly used. Such a noncontact communication system is employed in ticket gate systems used in public transportation systems such as trains and buses, and electronic money systems used in various stores, and vending machines.

FIG. 1 is an example of a configuration of a general noncontact communication system 10. The noncontact communication system 10 includes a reader/writer 11 and a transponder 12. For example, when the noncontact communication system 10 is employed in a ticket gate system, the reader/writer 11 is incorporated in a ticket gate and the transponder 12 is incorporated in an IC card typified by Suica (trademark) serving as a ticket.

When certain transmission information is to be transmitted from the reader/writer 11 to the transponder 12, a carrier signal of a sine wave (carrier wave) shown in FIG. 2A is subjected to ASK (amplitude shift keying) modulation in accordance with the certain transmission information before transmission. On the other hand, when certain digitalized response information shown in FIG. 2B is to be transmitted from the transponder 12 to the reader/writer 11, load modulation in which a voltage of a carrier signal is changed as shown in FIG. 2C by turning on and off a damping resistor R1 included in the transponder 12 in accordance with the certain response information using a switch is employed (refer to Japanese Unexamined Patent Application Publication No. 2001-307031, for example).

Then, the carrier signal which has been subjected to the load modulation is received by an antenna of the reader/writer 11. Note that, in the received carrier signal which has been subjected to the load modulation, a degree of the modulation is deteriorated in accordance with a distance between the reader/writer 11 and the transponder 12. The lower the degree of the modulation is, the more difficult detection of the response information is.

When the noncontact communication system 10 is used in ticket gate systems, communication between the reader/writer 11 and the transponder 12 should be enabled even when a distance between the reader/writer 11 and the antenna of the transponder 12 is equal to or larger than 10 cm taking convenience for users into consideration.

However, as described above, when the distance between the reader/writer 11 and the transponder 12 becomes large, the degree of modulation of the carrier signal which has been subjected to the load modulation is deteriorated, and therefore, it is difficult to detect the response information. Accordingly, to address this problem, a peak-to-peak voltage (hereinafter referred to as a “voltage Vpp”) of the carrier signal is enhanced to approximately 20 V.

FIG. 3 shows an example of a configuration of a general reader/writer 20 in a case where a voltage Vpp of a carrier signal is set to 20 V. The reader/writer 20 detects response information as a change of amplitude of a voltage of a carrier signal which has been subjected to load modulation.

It is assumed that a degree of modulation of the carrier signal which has been subjected to the load modulation and which has been received by the reader/writer 20 is set to 10% as shown in FIG. 4A. In this case, in the reader/writer 20, the carrier signal which has been subjected to the load modulation is subjected to full-wave rectification as shown in FIG. 4B, and a resultant signal is subjected to envelope detection by a peak-hold circuit so that a detection signal having a difference of 1 V is output as shown in FIG. 4C.

Here, not only a degree of modulation of a carrier signal which has been subjected to the load modulation is deteriorated when a distance between a reader/writer and an antenna of a transponder becomes large but also a communication dead zone which is referred to as an “NULL state” in which an amplitude difference is not generated in the carrier signal is generated between the reader/writer and the transponder. Specifically, as shown in FIG. 5, the communication dead zone is generated in a position in which a phase of a detection signal obtained when the carrier signal which has been subjected to the load modulation is subjected to detection in accordance with a change of amplitude of a voltage of the carrier signal is changed from a normal phase to a reversed phase.

### SUMMARY

In the communication dead zone, even when detection is performed on a carrier signal which has been subjected to load modulation in accordance with a change of amplitude of a voltage of the signal, response information is not detected.

However, even in the communication dead zone, since a phase of the carrier signal which has been subjected to the load modulation is changed. Therefore, when detection is performed in accordance with the phase change, response information may be detected.

Therefore, there is a demand for a noncontact communication system including a reader/writer which has an IQ detector (orthogonal detector) capable of detecting a change of amplitude of a voltage and a change of a phase.

Here, general IQ detectors are used in 50Ω systems which process high-frequency signals in many cases, and an allowable voltage Vpp of an input carrier signal is as small as approximately 2V. Therefore, as shown in FIG. 6, a reader/writer 30 including an attenuator disposed before the general IQ detector to attenuate the voltage Vpp of the carrier signal to 1/10 may be configured.

However, in the case of the configuration shown in FIG. 6, the carrier signal which is attenuated and which is input to the IQ detector has an amplitude difference of a voltage of 0.1 V as shown in FIG. 7, and accordingly, a detected signal output from the IQ detector also has a difference of as small as 0.1 V. As a result, sensitivity of detection of response information performed by the reader/writer 30 may be deteriorated.

It is desirable to detect information from a carrier signal which has been subjected to load modulation with high accuracy.

According to an embodiment of the present disclosure, there is provided a detection apparatus which detects, from a carrier signal which has been subjected to load modulation in accordance with information to be transmitted, the information. The detection apparatus includes a buffer configured to buffer the received carrier signal which has been subjected to the load modulation, and a detector configured to perform detection on the buffered carrier signal which has been subjected to the load modulation so as to detect the information.

The detector may include a switch which outputs the carrier signal which has been subjected to the load modulation without change as a detection signal to a downstream stage in synchronization with a local oscillation signal having a frequency the same as a frequency of the carrier signal or outputs a fixed voltage as a detection signal to the downstream stage.

The detector may include a first switch which outputs the carrier signal which has been subjected to the load modulation without change as a detection signal to a downstream stage in synchronization with a local oscillation signal having a frequency the same as a frequency of the carrier signal or outputs a fixed voltage as a detection signal to the downstream stage, and a second switch which outputs the carrier signal which has been subjected to the load modulation without change as a detection signal to the downstream stage in synchronization with a local oscillation signal having a phase which is delayed by 90 degrees relative to a phase of the local oscillation signal or outputs a fixed voltage as a detection signal to the downstream stage.

The detector includes a first switch which outputs the carrier signal which has been subjected to the load modulation without change as a detection signal to a downstream stage in synchronization with a first local oscillation signal having a frequency the same as a frequency of the carrier signal or outputs a fixed voltage as a detection signal to the downstream stage, a second switch which outputs the carrier signal which has been subjected to the load modulation without change as a detection signal to the downstream stage in synchronization with a second local oscillation signal having a phase which is delayed by 180 degrees relative to a phase of the first local oscillation signal or outputs a fixed voltage as a detection signal to the downstream stage, a third switch which outputs the carrier signal which has been subjected to the load modulation without change as a detection signal to the downstream stage in synchronization with a third local oscillation signal having a phase which is delayed by 90 degrees relative to the phase of the first local oscillation signal or outputs a fixed voltage as a detection signal to the downstream stage, and a fourth switch which outputs the carrier signal which has been subjected to the load modulation without change as a detection signal to the downstream stage in synchronization with a fourth local oscillation signal having a phase which is delayed by 270 degrees relative to the phase of the first local oscillation signal or outputs a fixed voltage as a detection signal to the downstream stage.

The detection apparatus may include a first subtractor configured to subtract the detection signal output from the first switch or the detection signal output from the second switch from the other and a second subtractor configured to subtract the detection signal output from the third switch or the detection signal output from the fourth switch from the other.

The detector may include a multiplier which outputs a result of multiplication of a local oscillation signal having a frequency the same as a frequency of the carrier signal and the carrier signal which has been subjected to the load modulation as a detection signal to the downstream stage.

The detection apparatus may further include an attenuator configured to attenuate a voltage of the received carrier signal which has been subjected to the load modulation so that the voltage becomes equal to or smaller than a power supply voltage of the buffer.

The detector may further include a removing unit configured to remove a pulse component included in the detection signal.

According to another embodiment of the present disclosure, there is provided a detection method including buffering the received carrier signal which has been subjected to the load modulation, and performing detection on the buffered carrier signal which has been subjected to the load modulation so as to detect the information.

Accordingly, in the detection apparatus, information is detected by buffering a received carrier signal which has been subjected to load modulation and performing detection on the buffered carrier signal which has been subjected to the load modulation.

According to a further embodiment of the present disclosure, there is provided a reception apparatus including a receiver configured to receive a carrier signal which has been subjected to load modulation in accordance with information to be transmitted, a buffer configured to buffer the received carrier signal which has been subjected to the load modulation, and a detector configured to perform detection on the buffered carrier signal which has been subjected to the load modulation so as to detect the information.

Accordingly, in the reception apparatus, a carrier signal which has been subjected to load modulation in accordance with the information to be transmitted is received, the received carrier signal which has been subjected to the load modulation is buffered, and the buffered carrier signal which has been subjected to the load modulation is detected so that the information is detected.

Accordingly, the information is detected with high accuracy from the carrier signal which has been subjected to the load modulation.

Accordingly, the information is detected with high accuracy from the received carrier signal which has been subjected to the load modulation.

### BRIEF DESCRIPTION OF THE DRAWINGS

FIG. 1 is a circuit diagram illustrating a configuration of a general noncontact communication system;

FIG. 2 is a diagram illustrating a change of a degree of modulation of a carrier signal which has been subjected to load modulation;

FIG. 3 is a diagram illustrating a configuration of a general reader/writer which detects a change of amplitude of a carrier signal which has been subjected to load modulation;

FIG. 4 is a diagram illustrating detection signals output from the reader/writer shown in FIG. 3;

FIG. 5 is a diagram illustrating a communication dead zone in a NULL state;

FIG. 6 is a circuit diagram illustrating a configuration of a reader/writer including an attenuator and a general IQ detector;

FIG. 7 is a diagram illustrating amplitude of a voltage of a carrier signal which is attenuated and which is input to the IQ detector included in the reader/writer shown in FIG. 6;

FIG. 8 is a block diagram illustrating a configuration of a signal detector according to an embodiment of the present disclosure;

FIG. 9 is a circuit diagram illustrating a configuration of a buffer;

FIG. 10 is a circuit diagram illustrating another configuration of the buffer;

FIG. 11 is a circuit diagram illustrating a configuration of a detection circuit;

FIG. 12 includes a waveform of a detection signal output from a detection circuit;

FIG. 13 includes a waveform of a detection signal output from another detection circuit;

FIG. 14 includes a waveform of a detection signal output from a further detection circuit;

FIG. 15 includes a waveform of a detection signal output from a still further detection circuit;

FIG. 16 is a flowchart illustrating operation of the signal detector shown in FIG. 8; and

FIG. 17 is a circuit diagram illustrating another configuration of the detection circuit.

### DETAILED DESCRIPTION OF EMBODIMENTS

Embodiments of the present disclosure will be described hereinafter with reference to the accompanying drawings.

### Embodiments

### Example of Configuration of Signal Detector

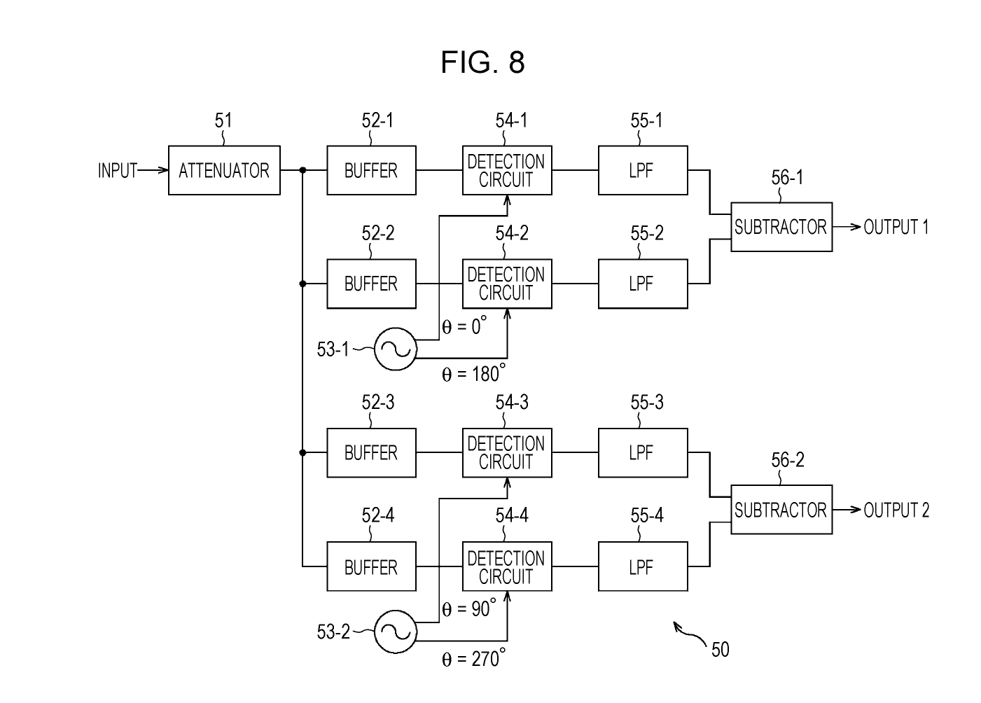

FIG. 8 shows a configuration of a signal detector 50 according to an embodiment of the present disclosure.

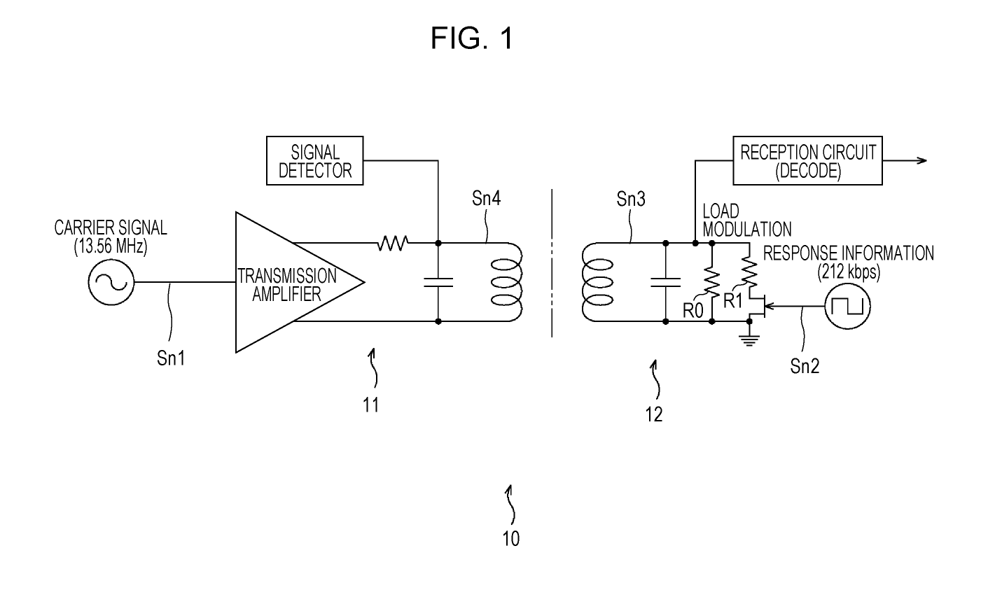

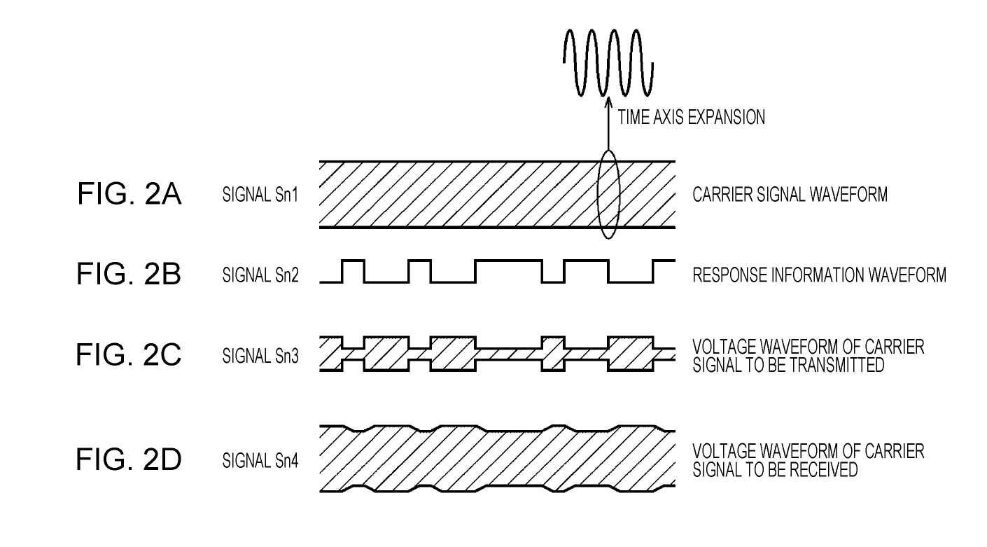

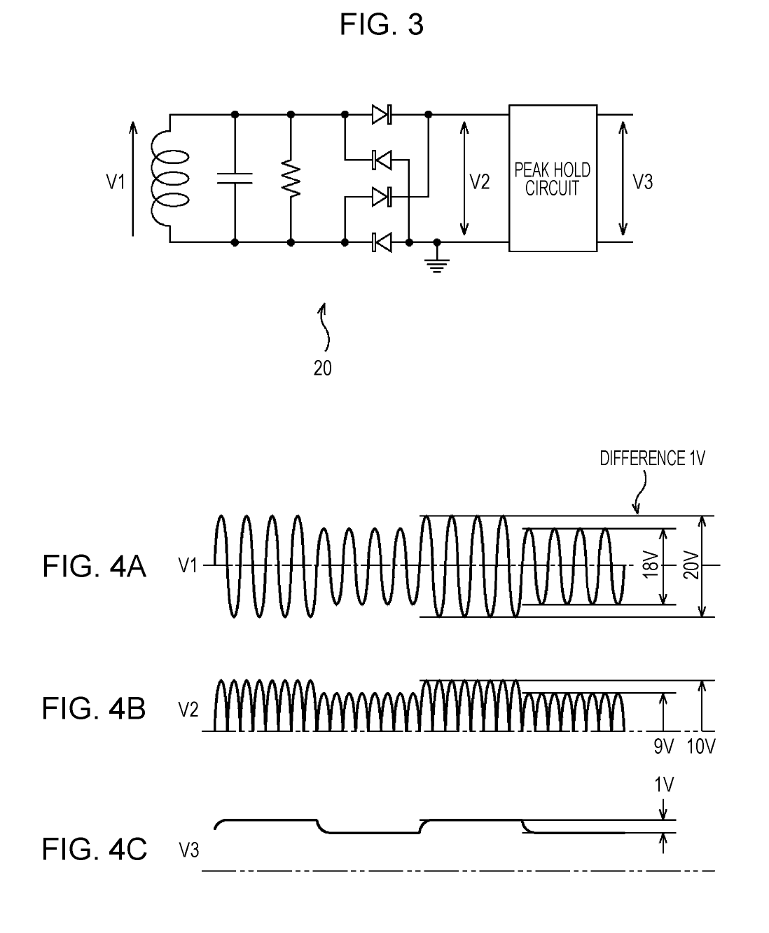

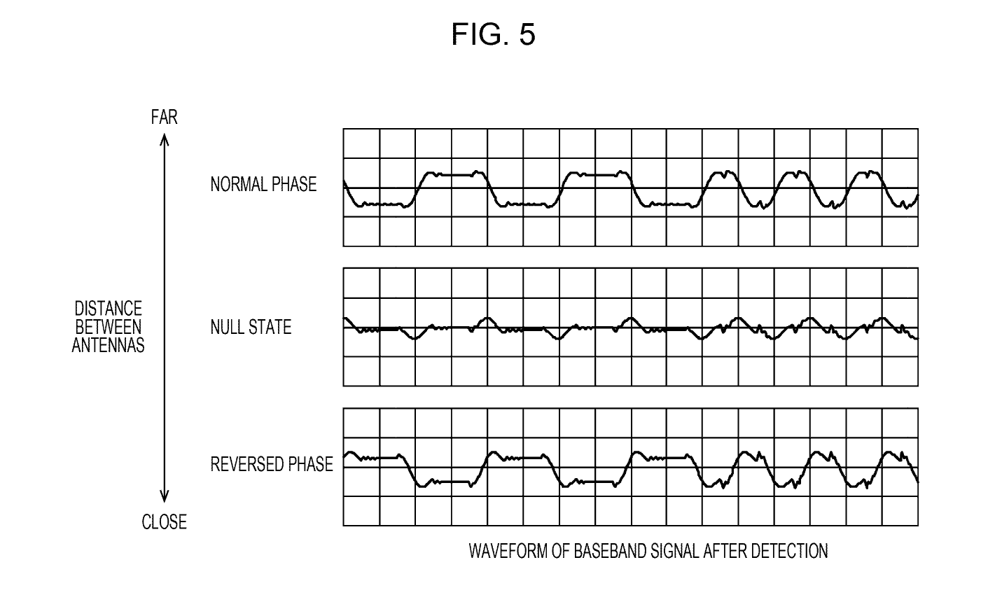

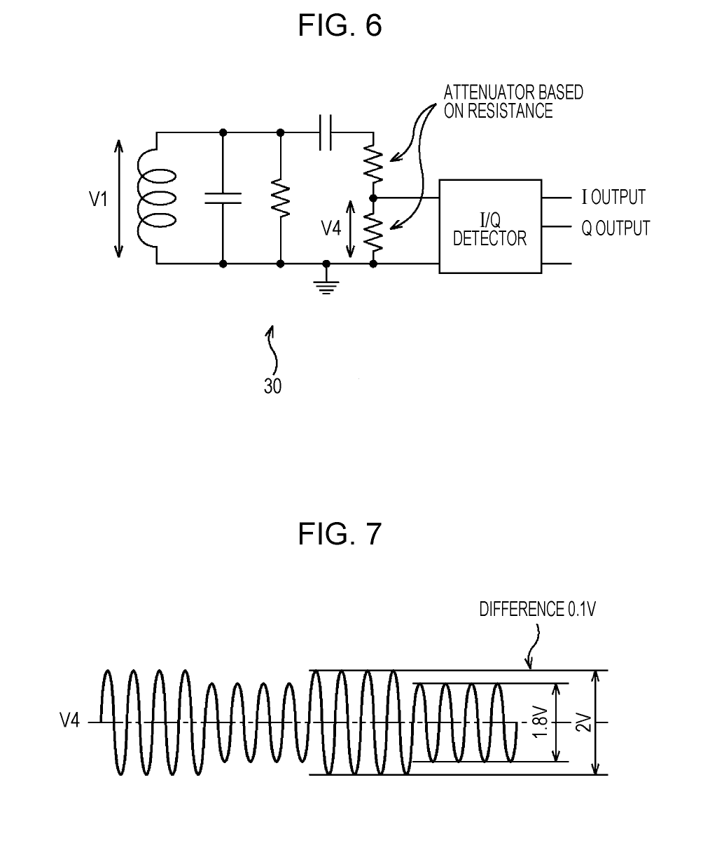

The signal detector 50 is incorporated in the reader/writer 11 of the noncontact communication system 10 shown in FIG. 1 and performs orthogonal detection using a carrier signal which has a high voltage (approximately 20 V) as an input and which has been subjected to load modulation in accordance with response information so that the response information is detected as a result of the detection.

The signal detector 50 includes a system which performs detection in accordance with a change of amplitude of a voltage of a carrier signal and a system which performs detection in accordance with a change of a phase of a voltage of a carrier signal. Furthermore, each of the systems is divided into a system which outputs a normal phase of a result of the detection and a system which outputs a reversed phase relative to a result of the detection.

The signal detector 50 includes an attenuator 51, buffers 52-1 to 52-4, local oscillators 53-1 and 53-2, detection circuits 54-1 to 54-4, low-pass filters (LPFs) 55-1 to 55-4, and subtractors 56-1 and 56-2.

When the buffers 52-1 to 52-4 are not distinguished from one another, the buffers 52-1 to 52-4 are simply referred to as a buffer 52 hereinafter. This is true for the other components.

The attenuator 51 compares a high voltage of a carrier signal which has been subjected to load modulation and which has been received by the antenna with a power supply voltage supplied to the buffer 52 in a downstream stage onward, attenuates the voltage of the carrier signal so that the voltage of the carrier signal is to be equal to or smaller than the power supply voltage, and outputs the attenuated voltage to the buffer 52. In other words, even when the voltage of the carrier signal is 20 V, if the power supply voltage supplied to the buffer 52 onward is set so as to be larger than a voltage Vpp of the carrier signal (for example, if the power supply voltage supplied to the buffer 52 onward is set to 24 V when the voltage Vpp of the carrier signal is 20V), the attenuation of the carrier signal is not performed. When the voltage of the carrier signal is fixedly set to be equal to or smaller than the power supply voltage supplied to the buffer 52 onward, the attenuator 51 may be omitted.

The buffer 52 buffers the carrier signal supplied from the attenuator 51. Since the buffer 52 is provided, the circuits disposed in the downstream stages (such as the detection circuit 54) are prevented from being affected by resonance of the antenna of the reader/writer.

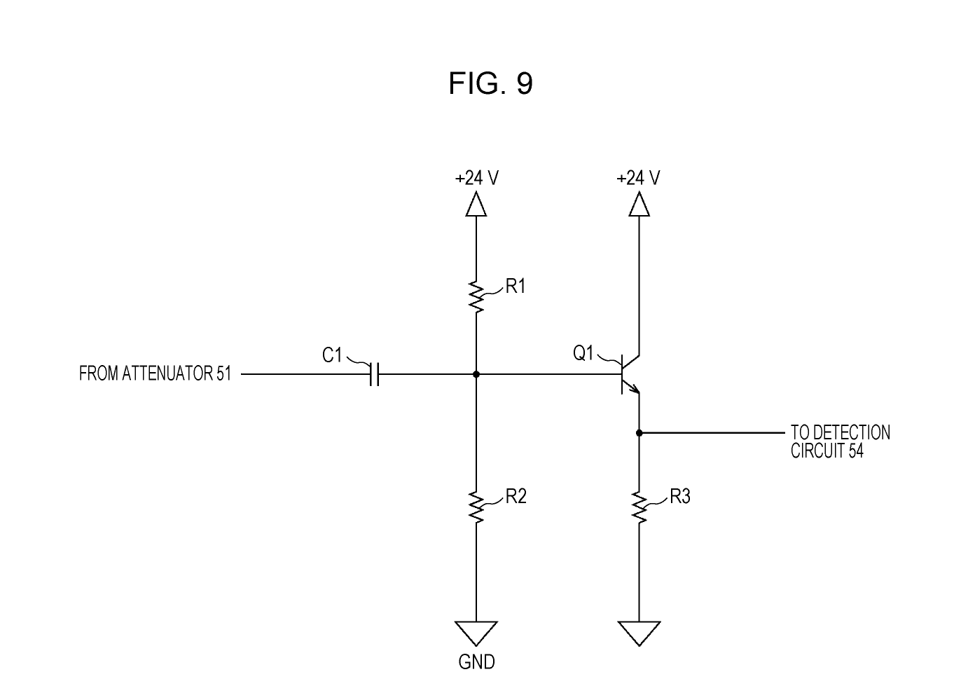

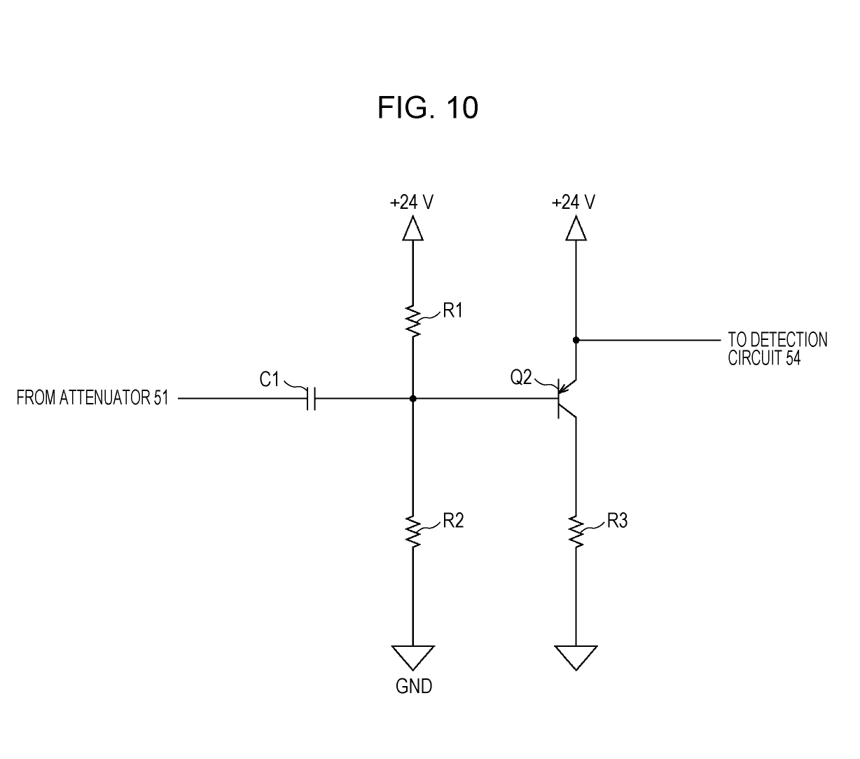

The buffer 52 may include an emitter follower including an NPN transistor Q1, for example, as shown in FIG. 9. Alternatively, as shown in FIG. 10, the buffer 52 may include an emitter follower including a PNP transistor Q2.

FIG. 8 is now referred to again. The local oscillator 53-1 oscillates a first local oscillation signal which is a rectangular wave which is synchronized with the carrier signal which is a sine wave and supplies the first local oscillation signal to the detection circuit 54-1. Hereinafter, it is assumed that a phase θ of the first local oscillation signal is used as a reference and is set to 0. Furthermore, the local oscillator 53-1 oscillates a second local oscillation signal which is delayed by 180° relative to the first local oscillation signal and supplies the second local oscillation signal to the detection circuit 54-2.

The local oscillator 53-2 oscillates a third local oscillation signal which is delayed by 90° relative to the first local oscillation signal and supplies the third local oscillation signal to the detection circuit 54-3.

Furthermore, the local oscillator 53-2 oscillates a fourth local oscillation signal which is delayed by 270° relative to the first local oscillation signal and supplies the fourth local oscillation signal to the detection circuit 54-4.

The detection circuit 54-1 outputs the buffered carrier signal to the LPF 55-1 without change when the first local oscillation signal is 0. On the other hand, the detection circuit 54-1 forcibly lowers a voltage of the buffered carrier signal to 0, that is, the detection circuit 54-1 performs a process similar to so-called half-wave rectification and outputs a resultant detection signal to the LPF 55-1 when the first local oscillation signal is 1.

Similarly, the detection circuits 54-2 to 54-4 outputs the buffered carrier signal to the LPFs 55-2 to 55-4 without change when the second to fourth local oscillation signals are 0. On the other hand, the detection circuits 54-2 to 54-4 forcibly lower the voltage of the buffered carrier signal to 0, that is, the detection circuits 54-2 to 54-4 perform a process similar to so-called half-wave rectification and output resultant detection signals to the LPFs 55-2 to 55-4 when the second to fourth local oscillation signals are 1.

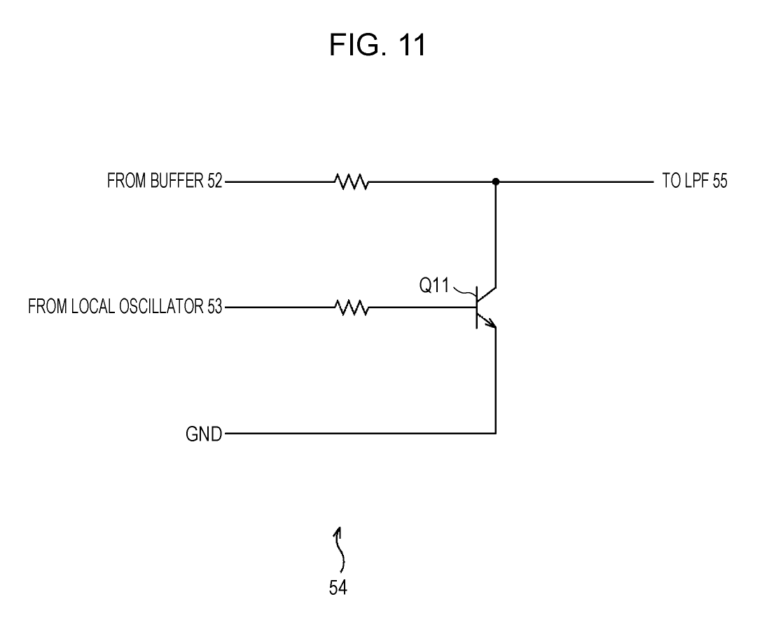

The detection circuit 54 specifically includes a transistor Q11 serving as a switch which is turned on or off in accordance with a local oscillation signal as shown in FIG. 11, for example. In this configuration, when the local oscillation signal is 0, the transistor Q11 is turned off, and as a result, the carrier signal is output without change to the downstream stage. On the other hand, when the local oscillation signal is 1, the transistor Q11 is turned on, and accordingly, a voltage of 0V is output to the downstream stage.

FIG. 8 is now referred to again. The LPFs 55-1 and 55-2 perform averaging by removing pulse components of the detection signals supplied from the detection circuits 54-1 and 54-2, respectively, and outputs resultant signals to the subtractor 56-1. Similarly, the LPFs 55-3 and 55-4 perform averaging by removing pulse components of the detection signals supplied from the detection circuits 54-3 and 54-4, respectively, and output resultant signals to the subtractor 56-2.

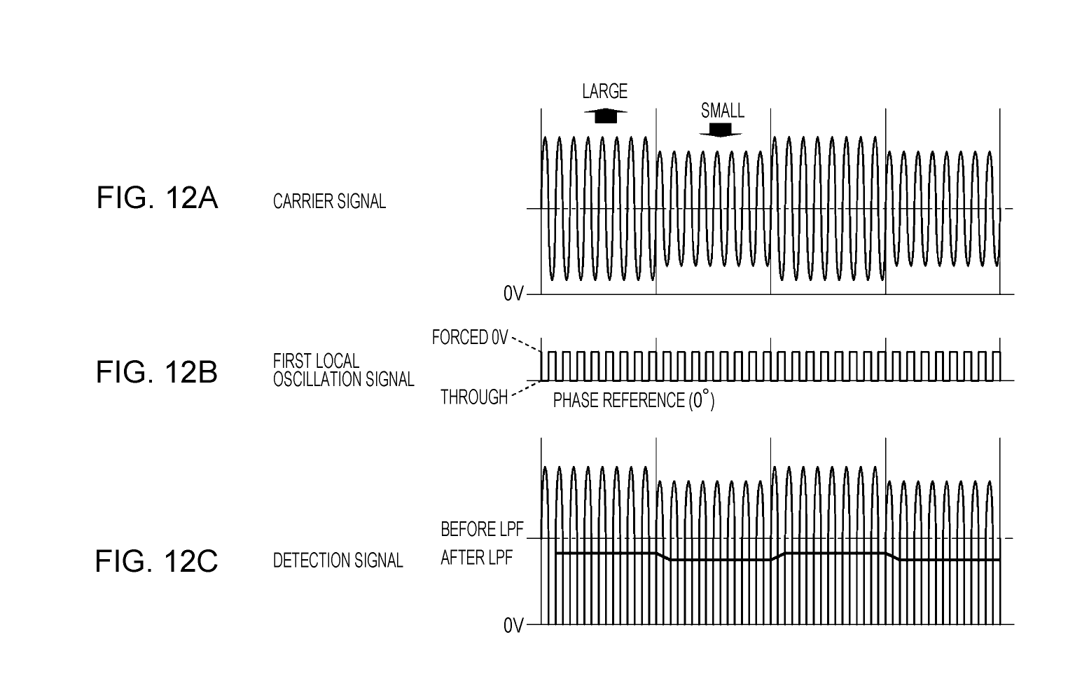

FIG. 12 shows waveforms obtained before and after a detection signal is supplied from the detection circuit 54-1 to the LPF 55-1. As shown in FIG. 12, the detection circuit 54-1 which performs switching in synchronization with the first local oscillation signal outputs an amplitude modulation component of the carrier signal which has been subjected to the load modulation as a detection signal.

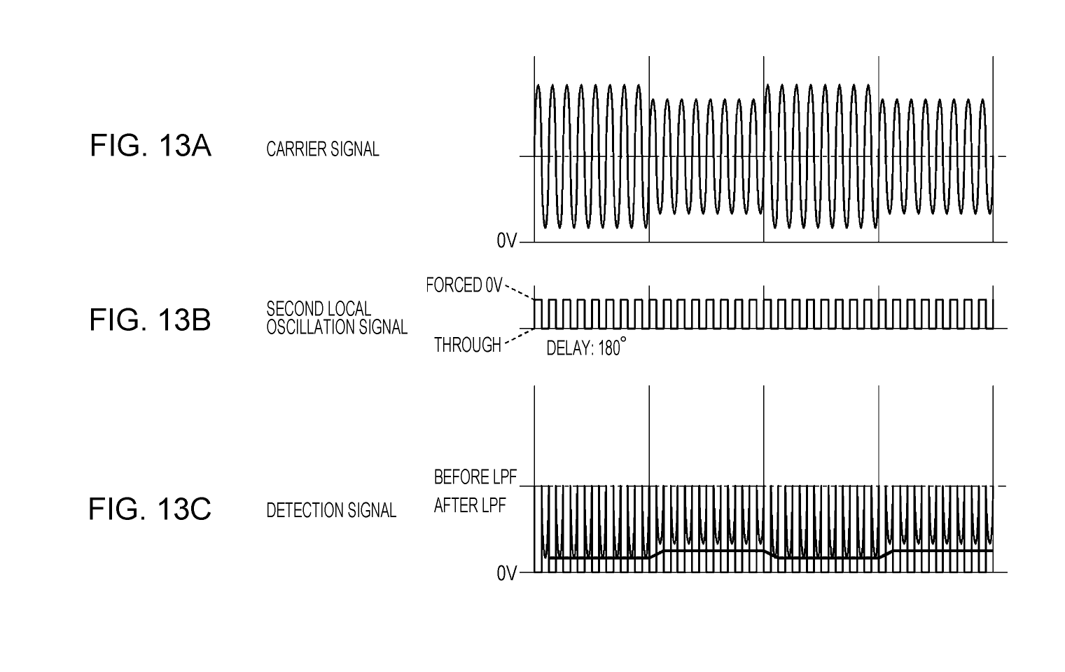

FIG. 13 shows waveforms obtained before and after a detection signal is supplied from the detection circuit 54-2 to the LPF 55-2. As shown in FIG. 13, the detection circuit 54-2 which performs switching in synchronization with the second local oscillation signal outputs an amplitude modulation component of the carrier signal which has been subjected to the load modulation as a detection signal in a state in which positive or negative is reversed relative to the signal output from the detection circuit 54-1.

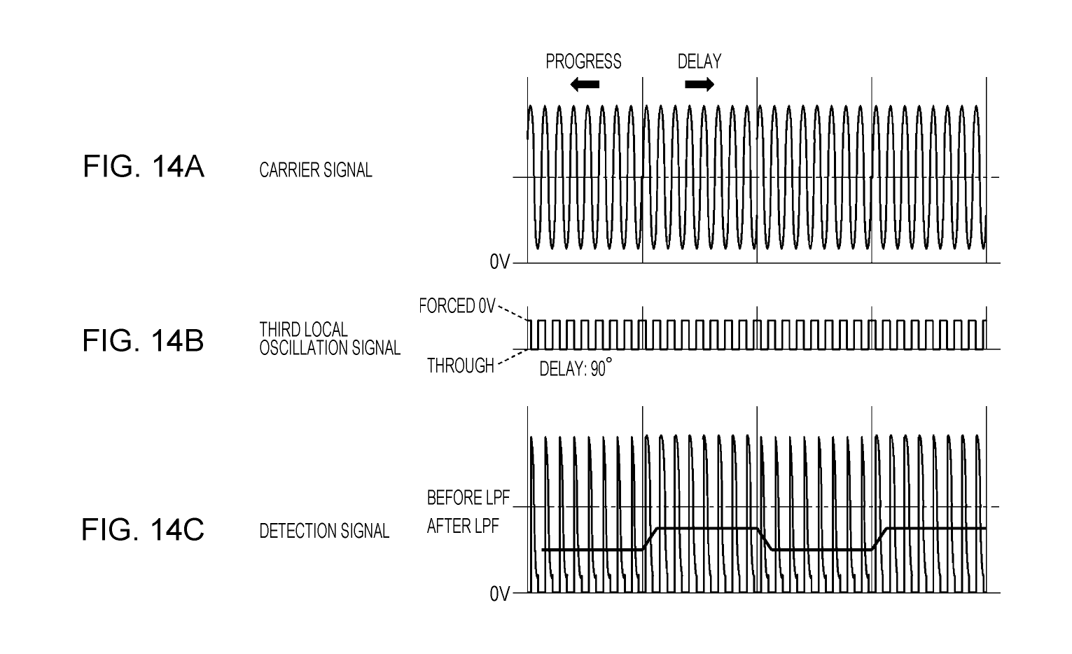

FIG. 14 shows waveforms obtained before and after a detection signal is supplied from the detection circuit 54-3 to the LPF 55-3. As shown in FIG. 14, the detection circuit 54-3 which performs switching in synchronization with the third local oscillation signal outputs a phase modulation component of the carrier signal which has been subjected to the load modulation as a detection signal.

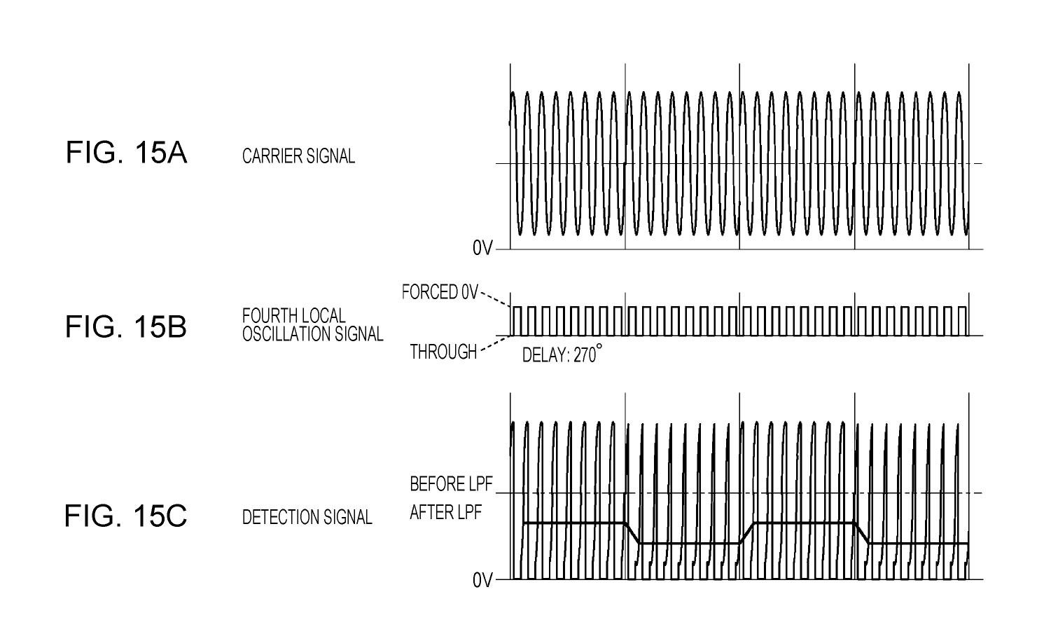

FIG. 15 shows waveforms obtained before and after a detection signal is supplied from the detection circuit 54-4 to the LPF 55-4. As shown in FIG. 15, the detection circuit 54-4 which performs switching in synchronization with the fourth local oscillation signal outputs a phase modulation component of the carrier signal which has been subjected to the load modulation as a detection signal in a state in which positive or negative is reversed relative to the signal output from the detection circuit 54-3.

FIG. 8 is now referred to again. The subtractor 56-1 obtains a first detection signal based on an amplitude modulation component in which a difference between the maximum value and the minimum value is clearly obtained by subtracting the signal output from one of the LPFs 55-1 and 55-2 from the signal output from the other. Similarly, the subtractor 56-2 obtains a second detection signal based on a phase modulation component in which a difference between the maximum value and the minimum value is clearly obtained by subtracting the signal output from one of the LPFs 55-3 and 55-4 from the signal output from the other.

### Description of Operation

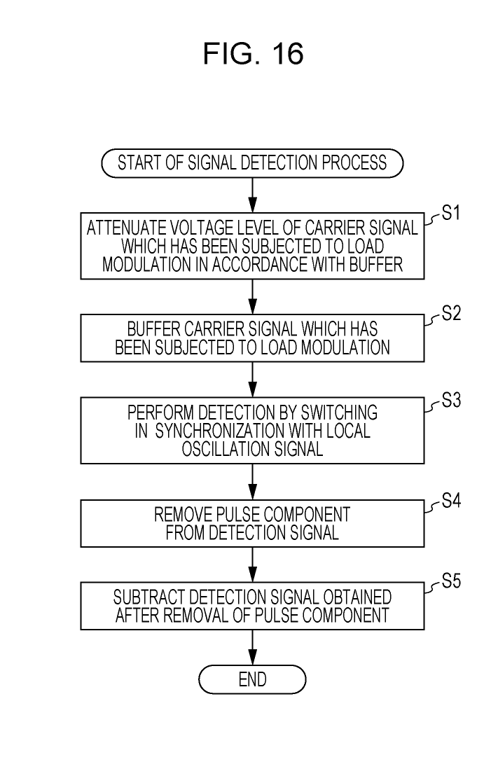

FIG. 16 is a flowchart illustrating operation of the signal detector 50 (hereinafter referred to as a “signal detection process”).

The signal detection process is executed by the signal detector 50 on a carrier signal which has been subjected to load modulation and which has been supplied from the reader/writer in the noncontact communication system.

In step S2, the attenuator 51 attenuates a high voltage of the carrier signal which has been subjected to the load modulation and which has been received by the antenna so that a voltage becomes equal to or smaller than the power supply voltage supplied to the buffer 52 onward and outputs the attenuated voltage to the buffers 52-1 to 52-4. In step S2, the buffers 52-1 to 52-4 buffer the carrier signal supplied from the attenuator 51.

In step S3, the detection circuits 54-1 to 54-4 perform detection on the carrier signal by performing switching in accordance with the first to fourth local oscillation signals respectively input, and output resultant detection signals to the LPFs 55-1 to 55-4, respectively.

In step S4, the LPFs 55-1 to 55-4 perform averaging by removing pulse components of the detection signals supplied from the detection circuits 54-1 and 54-4, respectively, in an earlier stage and output resultant signals to the subtractor 56-1 or 56-2. In step S5, the subtractor 56-1 obtains a first detection signal based on an amplitude modulation component in which a difference between the maximum value and the minimum value is clearly obtained by subtracting the signal output from one of the LPFs 55-1 and 55-2 from the signal output from the other. Similarly, the subtractor 56-2 obtains a second detection signal based on a phase modulation component in which a difference between the maximum value and the minimum value is clearly obtained by subtracting the signal output from one of the LPFs 55-3 and 55-4 from the signal output from the other. In this way, the signal detection process is terminated.

According to the signal detection process, the first detection signal and the second detection signal which are based on the amplitude modification component and the phase modification component, respectively, may be simultaneously obtained from the carrier signal which has been subjected to the load modulation. Accordingly, the problem on the communication dead zone caused by a distance between the reader/writer and the transponder may be substantially addressed.

### First Modification

In the example of the configuration of the signal detector 50 shown in FIG. 8, the order of the LPF 55 and the subtractor 56 may be replaced by each other. That is, a detection signal may be supplied from the detection circuit 54 to the subtractor 56, and a signal output from the subtractor 56 may be averaged by the LPF 55. In this case, the number of LPFs 55 may be reduced from four to two.

### Second Modification

The detection circuit 54 is not limited to the example of the configuration including the switch operated in accordance with the local oscillation signal shown in FIG. 11 and other configuration examples may be employed.

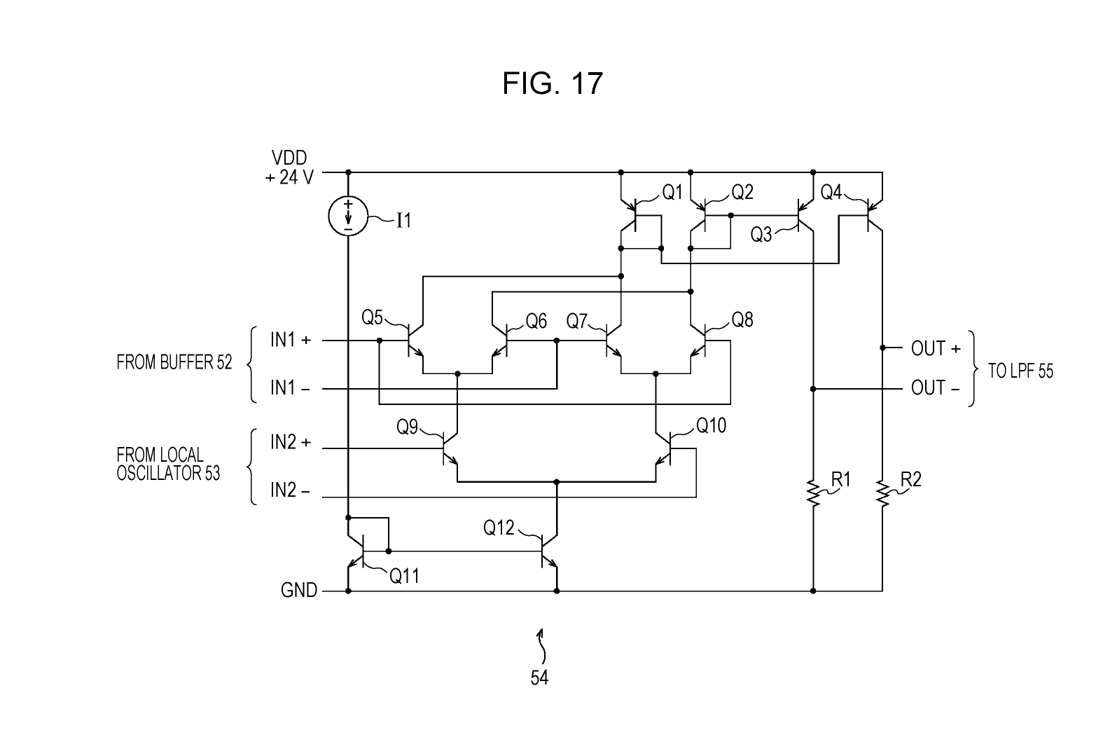

FIG. 17 is a circuit diagram (principle diagram) illustrating another configuration of the detection circuit 54. In this configuration example, the detection circuit 54 includes a multiplier and a carrier signal and a local oscillation signal which are to be subjected to multiplication are input to transistors which are vertically overlapped in a power supply voltage, respectively. Therefore, an allowable voltage Vpp relative to the input signal is appropriately half of a power supply voltage. Note that, FIG. 17 is the principle diagram, and when the detection circuit 54 is actually configured, elements such as resistors and capacitors should be additionally provided, and furthermore, property of a pair between the elements should be provided. Accordingly, deterioration of performance caused by variation is unavoidable.

Note that the signal detector in the foregoing embodiment is applicable to a reception apparatus which receives a signal which has been subjected to load modulation in addition to a reader/writer of a noncontact communication system.

In this specification, the term “system” represents an entire apparatus including a plurality of devices.

Note that the embodiment of the present disclosure is not limited to the foregoing embodiments and various modifications may be made without departing from the scope of the present disclosure.

What is claimed is:

1. A detection apparatus which detects, from a carrier signal which has been subjected to load modulation in accordance with information to be transmitted, the information, the detection apparatus comprising:
a buffer configured to buffer the received carrier signal which has been subjected to the load modulation; and
a detector configured to perform detection on the buffered carrier signal which has been subjected to the load modulation so as to detect the information.

2. The detection apparatus according to claim 1,
wherein the detector includes a switch which outputs the carrier signal which has been subjected to the load modulation without change as a detection signal to a downstream stage in synchronization with a local oscillation signal having a frequency the same as a frequency of the carrier signal or outputs a fixed voltage as a detection signal to the downstream stage.

3. The detection apparatus according to claim 1,
wherein the detector includes
a first switch which outputs the carrier signal which has been subjected to the load modulation without change as a detection signal to a downstream stage in synchronization with a local oscillation signal having a frequency the same as a frequency of the carrier signal or outputs a fixed voltage as a detection signal to the downstream stage, and
a second switch which outputs the carrier signal which has been subjected to the load modulation without change as a detection signal to the downstream stage in synchronization with a local oscillation signal having a phase which is delayed by 90 degrees relative to a phase of the local oscillation signal or outputs a fixed voltage as a detection signal to the downstream stage.

4. The detection apparatus according to claim 1,
wherein the detector includes
a first switch which outputs the carrier signal which has been subjected to the load modulation without change as a detection signal to a downstream stage in synchronization with a first local oscillation signal having a frequency the same as a frequency of the carrier signal or outputs a fixed voltage as a detection signal to the downstream stage,
a second switch which outputs the carrier signal which has been subjected to the load modulation without change as a detection signal to the downstream stage in synchronization with a second local oscillation signal having a phase which is delayed by 180 degrees relative to a phase of the first local oscillation signal or outputs a fixed voltage as a detection signal to the downstream stage,
a third switch which outputs the carrier signal which has been subjected to the load modulation without change as a detection signal to the downstream stage in synchronization with a third local oscillation signal having a phase which is delayed by 90 degrees relative to the phase of the first local oscillation signal or outputs a fixed voltage as a detection signal to the downstream stage, and
a fourth switch which outputs the carrier signal which has been subjected to the load modulation without change as a detection signal to the downstream stage in synchronization with a fourth local oscillation signal having a phase which is delayed by 270 degrees relative to the phase of the first local oscillation signal or outputs a fixed voltage as a detection signal to the downstream stage.

5. The detection apparatus according to claim 4, comprising:
a first subtractor configured to subtract the detection signal output from the first switch or the detection signal output from the second switch from the other; and
a second subtractor configured to subtract the detection signal output from the third switch or the detection signal output from the fourth switch from the other.

6. The detection apparatus according to claim 1,
wherein the detector includes a multiplier which outputs a result of multiplication of a local oscillation signal having a frequency the same as a frequency of the carrier signal and the carrier signal which has been subjected to the load modulation as a detection signal to the downstream stage.

7. The detection apparatus according to claim 1, further comprising:
an attenuator configured to attenuate a voltage of the received carrier signal which has been subjected to the load modulation so that the voltage becomes equal to or smaller than a power supply voltage of the buffer.

8. The detector according to claim 7, further comprising:
a removing unit configured to remove a pulse component included in the detection signal.

9. A detection method of a detection apparatus which detects, from a carrier signal which has been subjected to load modulation in accordance with information to be transmitted, the information, the detection method comprising:
buffering the received carrier signal which has been subjected to the load modulation; and
performing detection on the buffered carrier signal which has been subjected to the load modulation so as to detect the information.

10. A reception apparatus comprising:
a receiver configured to receive a carrier signal which has been subjected to load modulation in accordance with information to be transmitted;
a buffer configured to buffer the received carrier signal which has been subjected to the load modulation; and
a detector configured to perform detection on the buffered carrier signal which has been subjected to the load modulation so as to detect the information.
